(19) United States
(12) Patent Application Publication
(10) Pub. No.: US 2020/0175501 A1
(43) Pub. Date: Jun. 4, 2020

(54) METHODS AND APPARATUS FOR VALUE TRANSFER

(71) Applicant: Token IQ, Inc., Scottsdale, AZ (US)

(72) Inventor: Mark VANGE, Scottsdale, AZ (US)

(21) Appl. No.: 16/639,617

(22) PCT Filed: Aug. 24, 2018
(86) PCT No.: PCT/US2018/047921

§ 371 Date: Feb. 17, 2020

Related U.S. Application Data
(60) Provisional application No. 62/550,495, filed on Aug. 25, 2017.

(51) Int. Cl. G06Q 20/36; G06Q 20/40; G06Q 20/02

(52) U.S. Cl. CPC G06Q 20/3674; G06Q 2220/00; G06Q 20/02; G06Q 20/4012

(57) ABSTRACT

Methods and apparatus for tokenizing securities according to various aspects of the present technology include various modules for facilitating a controlled exchange environment for tokens residing on one or more distributed ledgers. The modules are configured to create and issue tokens on one or more distributed ledgers and verify that a wallet of a recipient or other entity is qualified to receive the token before allowing the transfer of the token into the wallet. The modules may also restrict access to the token until one or more predetermined events take place.

### CROSS-REFERENCES TO RELATED APPLICATIONS

This application claims the benefit of U.S. Provisional Patent Application No. 62/550,495, filed Aug. 25, 2017, and incorporates the disclosure of the application by reference.

### BACKGROUND OF THE TECHNOLOGY

The recent explosion in initial token offerings (the sale of tokenized assets often referred to as ITOs, ICOs, or Crowdfunding) has created a flurry of headlines and generated a tremendous level of activity culminating in hundreds of offerings, many of which have raised the equivalent of hundreds of millions of dollars. In a typical ITO scenario, the issuer makes tokens (sometimes referred to as coins) available to the public in exchange for coin or fiat so that the successful issuer may end up holding a great deal of coin (tens or even hundreds of millions USD worth). Although the coin represents a certain amount of established fiat currency, the issuer must generally convert the coin into a fiat currency to fund operational activities such as: the development of the business; paying for employees; rent; materials; supplies; taxes; professional services; and other business expenses.

While there is a great deal of value tied up in various types of coin, the market depth remains very shallow, which in practical terms means that any attempt to sell a significant amount of coin can easily disrupt the coin market more broadly and drive the value of such a sale down rapidly and critically, not only for the issuer but for the entire market. Disruptions as large as 30% have been known to occur when relatively small percentages of a given coin are sold at once. The result to the issuer is that a single transaction not only caused the market to drop by 30% but also generated far less of the desired currency than the proceeds that would have been generated based on the spot price at the time the order was placed. Furthermore, reverberations from such a rapid drop may lead to a “flash crash” that could, at least temporarily, drive the market down even further.

ITOs also present legal questions relating to purchaser jurisdiction and regulatory and taxation requirements in a given jurisdiction. As the legislative and jurisdictional environment for ITOs begins to clarify with announcements from national regulatory entities such as the U.S. Securities and Exchange Commission (SEC), it becomes increasingly important for an Issuer of an ITO to think through their strategy not only in terms of the jurisdiction and regulatory environment in which their corporate identity will operate, but also where they will make their tokens available. The strategy pursued by most issuers currently is to domicile in a jurisdiction that is perceived to be ICO “friendly” and perhaps simply not permit the direct purchase of tokens from jurisdictions deemed as potentially problematic such as the USA and China. The simple reason for this strategy is one of minimizing cost, complexity and risk of non-compliance. However, this strategy may not be the most efficient system as the technology evolves and becomes more widely accepted. For example, issuers are unable to control the post-release trading of their tokens that could be as likely as not to end up in the hands of proscribed owners. In addition, issuers may leave a great deal of value and liquidity on the table by not allowing access to many of the world's most affluent recipients. This embargo strategy is neither prudent nor economically optimal as it leaves the residents and citizens of many of the world's wealthiest countries unable to participate in ITOs, thus diminishing the value of the entire sector as well as of individual assets.

### SUMMARY OF THE TECHNOLOGY

Methods and apparatus for tokenizing securities according to various aspects of the present technology include various modules for facilitating a controlled exchange environment for tokens residing on one or more distributed ledgers. The modules are configured to create and issue tokens on one or more distributed ledgers and verify that a wallet of a recipient or other entity is qualified to receive the token before allowing the transfer of the token into the wallet. The modules may also restrict access to the token until one or more predetermined events take place.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is a block diagram of a tokenization system in accordance with an exemplary embodiment of the present technology;

FIG. 2 is a detailed view of the tokenization system in accordance with an exemplary embodiment of the present technology;

FIG. 3 is a flowchart for the issuer module and issuer token creation process in accordance with an exemplary embodiment of the present technology;

FIG. 4 is a flowchart for the recipient account process in accordance with an exemplary embodiment of the present technology;

FIG. 5 is a flowchart for the KYC token process in accordance with an exemplary embodiment of the present technology;

FIG. 6 is a flowchart for the token transfer module in accordance with an exemplary embodiment of the present technology;

FIG. 7 is a flowchart for a funds transfer module in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

Various aspects of the present invention may be described in terms of functional block components and various processing steps. Such functional blocks may be realized by any number of mechanical, virtual, hardware, or software components configured to perform the specified functions and achieve the various results. For example, exemplary embodiments of the present invention may employ various tokens, digitized assets, distributed ledger protocols, shared, centralized, semi-centralized, or decentralized electronic files, private or publicly accessible distributed ledgers, and the like, which may carry out a variety of functions. In addition, various aspects of the present invention may be practiced in conjunction with any number of value transfer, commercial, and monetary environments, and the systems and methods described are merely exemplary applications for the invention. Further, exemplary embodiments of the present invention may employ any number of conventional techniques for communication, encryption, and the like.

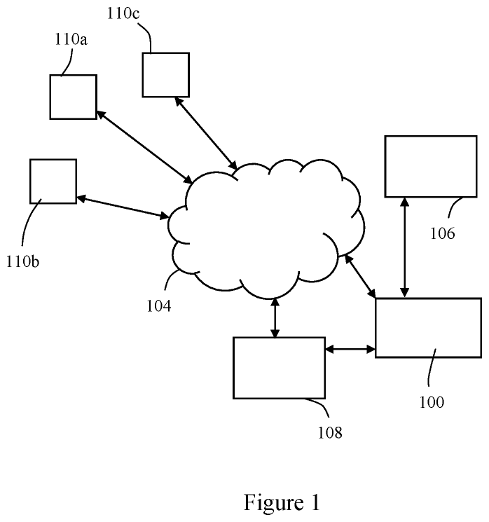

Methods and apparatus for a system of tokenizing securities according to various aspects of the present technology may operate in conjunction with any peer-to-peer network using a distributed ledger (DL) such as a blockchain. For example, referring to FIG. 1, a tokenization system 100 is configured to facilitate the transfer of one or more issuer tokens created by an issuer 108 to one or more wallets 110a, 110b, 110c owned by a recipient in exchange for a predetermined amount of coin transferred from the recipient's wallet 110 to the issuer 108 or a transfer of fiat currency directly to an issuer's account held at a financial institution. The issuer token and the recipient wallet 110 exist on a DL 104 such as a blockchain. The DL 104 may comprise a preexisting system such as Ethereum® or Stellar or the DL may be unique to a given issuer 108. The DL 104 may also incorporate other technologies not yet identified. A recipient may be a person, group of people, or an entity such as an exchange, an investment group, a depository service, a custodian, a trust, and the like.

Alternatively, the issuer token may be released or issued on a first DL 104 and the recipient's wallet 110 may exist on a second DL (not shown). The tokenization system 100 may be configured to create a map between the two DLs so that a transaction occurring on one DL is reflected or can be verified on the other DL. The tokenization system 100 may also be configured to transfer the issuer token over an exchange based transaction occurring off the DL 104.

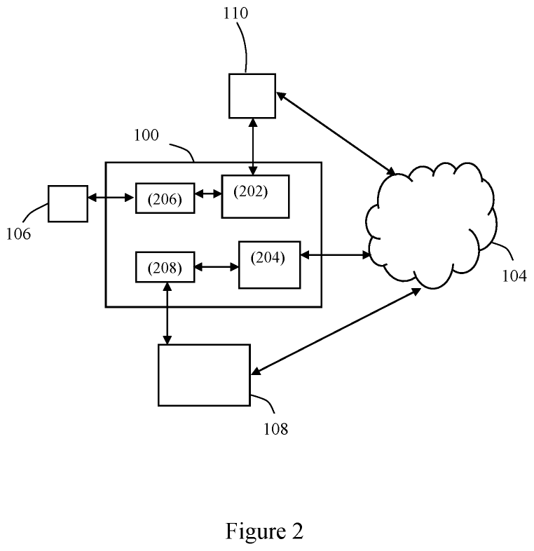

The tokenization system 100 may comprise one or more modules suitably configured to enable both the initial transfer of the issuer token from the issuer 108 to a first recipient's wallet 110 over the DL 104 and any subsequent transfer of the issuer token from the first recipient's wallet 110a to one or more additional recipient wallets 110b, 110c over the distributed DL 104. For example, and referring now to FIG. 2, in one embodiment, the tokenization system 100 may comprise a recipient module 202, a token transfer module 204, a qualification module 206, and an issuer module 208. The issuer module 208 generates issuer tokens on the DL 104 according to a set of issuer data corresponding to any type of token offering such as an ITO. The issuer module 208 may comprise any suitable system for receiving the set of issuer data and generating tokens on the DL 104. The issuer data may comprise any suitable information such as a description of the asset/security represented by the issuer token and an initial value for the issuer token.

The issuer data may further comprise a set of transfer criteria associated with the issuer token. The transfer criteria may comprise imposed restrictions set by the issuer 108 pertaining to who may be allowed to purchase, receive, acquire, or otherwise trade the corresponding token. For example, the transfer criteria may comprise jurisdictional restrictions that prevent recipients from predetermined countries or regions from purchasing or receiving the issuer token(s). Restrictions may also include other factors such as whether or not the recipient is a “qualified recipient” as determined by one or more government agencies such as the SEC.

The transfer criteria may also comprise restrictions on when an issuer token may be transferred to the recipient. In one embodiment, the transfer criteria may correspond to a predetermined event or occurrence. For example, the transfer criteria may include a timing provision such that the token may be transferable to the recipient but cannot be fully transferred until a predetermined amount of time has elapsed. The timing provision may be tied to a specific date or an amount of time corresponding to a vesting period or an option period. The timing provision may also be tied to milestones, deadlines, commitment or promise dates, payment deadlines, weather-driven events and other dependencies normally found in customary commercial contracts. Similarly, the timing provision may be associated with another event such that the token may be held in escrow or a wallet 110 and not released to the recipient's wallet 110 until one or more other events, such as compliance with contractual requirements, have taken place.

The issuer module 208 may also be configured to release or otherwise simultaneously issue the issuer token(s) on two or more DLs (not shown) in parallel. Issuing the issuer tokens on more than one DL may provide benefits relating to increased security, backup protection for recipients, and/or placing a first set of restrictions on a first DL and second set of restrictions on a second DL.

The recipient module 202 is used to create a recipient account according to a set of recipient data. The recipient data may comprise any desired information such as personally identifiable information of the recipient and data corresponding to the recipient's wallet 110. The recipient module 202 may comprise any suitable device or system for maintaining user accounts. The recipient module 202 may also be suitably configured to allow the recipient to access and manage their account and/or wallet 110 over any suitable communication network such as the Internet. Accordingly, the recipient module 202 may include a user interface that is configured to operate with an application server to allow the recipient to remotely navigate and manage their account.

The recipient module 202 may also be configured to provide recipients with a lockout recovery process. A common problem with prior art cryptographic assets is that if a user forgets their password, regaining access to the wallet 110 in which the assets may be stored may be impossible. The result of this is that any coin or tokens in the wallet 110 may be lost to the user forever.

The lockout recovery process may comprise any suitable process for requiring the recipient to validate their identity as the true owner of the recipient account. For example, in one embodiment, a multi-step process that incorporates one or more biometric elements may be used to confirm the recipient's identity before returning control of the account and corresponding wallet 110.

Alternatively, the lockout recovery process may not allow the recipient to regain access to their wallet 110, but may instead allow for the reissuance of any issuer token(s) held in the original wallet 110 into a new wallet 110. For example, due to the nature of DLs, once the password to a first wallet 110a is lost, it simply may not be possible for the recipient to ever regain access to that wallet 110a. Therefore, the recipient module 202 may be configured to obtain a replacement issuer token once it is shown that the original issuer token is longer accessible and transfer that issuer token into the new wallet 110b. The original issuer token may then be invalidated or otherwise rendered unusable to prevent it from later being traded or used. The recipient module 202 may also remove or otherwise delete a KYC token corresponding to the original issuer token from the recipient's original wallet 110 thereby preventing the original issuer token from ever being transferred to another recipient in the event that the original wallet 110a is accessed at a later date.

In yet another embodiment, the recipient module 202 may be configured to move the issuer token from the recipient's original wallet 110a into the new wallet 110b. In case of issuer tokens being issued on multiple DLs, the recipient module 202 may only allow one DL at a time to be honored and used to provide the recipient access to the issuer token. If access is somehow lost the first DL, then the recipient module 202 may transfer access to the issuer token to the second DL thereby maintaining the complete transaction history of the issuer token while preserving the value and access to the assets held in the wallet 110 for the recipient.

Referring now to FIGS. 1 and 2, the qualification module 206 may be configured to obtain data from the recipient module 202 and interact with a third party 106 provider of information relating to a given recipient account to confirm at least a portion of the recipient data. For example, the third party may verify the identity of the recipient using a process known as Know Your Client (KYC) and provide the qualification module 206 with a set of KYC data that is associated with the recipient. The amount of disclosure required to create the set of KYC data may vary with jurisdiction or by a particular issuer's 108 requirements. For example, for persons in the United States, the KYC data may comprise information such as name, address, state of residence, age, whether or not they are a Qualified Recipient (as defined by the SEC), and the recipient's social security number. As another example, KYC data for residents of the European Union may include video identification information.

The qualification module 206 may use the KYC data and the recipient data to generate a KYC token that is stored in a location accessible by the qualification module 206 such as the recipient's account or the recipient's wallet 110. The KYC token allows the recipient to assert their residency or to identify themselves and validate their identities to the tokenization system 100 while preserving anonymity from the issuer 108.

The qualification module 206 may also generate a KYC score for the KYC token based on a calculated value for certainty associated with the KYC data. The KYC score may comprise any suitable measurement system for providing an indication of the level of certainty associated with the KYC data. For example, in one embodiment, the KYC score may comprise a number between 1 and 100, wherein the higher the calculated score is, the higher the level of certainty is with the KYC data. An alternative embodiment may use a letter grade from A to F, with “A” representing the highest level of certainty, “F” representing the lowest level of certainty, and the interim letters representing level of certainty in between the two.

The issuer 108 may use the KYC score to assign threshold levels that may be required before a given type of transaction is allowed to occur. For example, the issuer 108 may require a baseline KYC score before the recipient is allowed to obtain an issuer token in an inter-wallet transaction between individual recipients and an even higher KYC score before the recipient is allowed to obtain an issuer token through the token offering. Other KYC scores may be used to limit other types of transaction such as: the sale of issuer tokens back to the issuer 108; execution of rights; and/or the execution of token reclamation.

The qualification module 206 may also be configured to ensure that the issuer 108 is a qualified entity that recipients can trust. For example, the qualification module 206 may obtain information from the issuer 108 to ensure that the issuer is compliant with Anti-Money Laundering (AML) requirements. In one embodiment, the qualification module 206 may create an AML token for the issuer 108 and store it the issuer's wallet 110. The qualification module 206 may use any suitable process for creating the AML token for the issuer 108. For example, the qualification module 206 may subject the issuer 108 to a similar process of obtaining KYC data for the issuer as it does for recipients. Alternatively, the qualification module 206 may create the AML token based on the existence of one or more KYC tokens in the wallets 110 of individuals associated with the issuer 108 such as investors, officers, board members, or other entities. The existence of the individual KYC tokens may act as a source of authority ensuring others that the issuer 108 is compliant with AML regulations.

The token transfer module 204 manages the transfer of the issuer token(s) between the issuer 108 and one or more recipients over the DL 104 and without the need to use a traditional exchange that is not on the “chain” of the DL 104. The token transfer module 204 may comprise any suitable system for providing the issuer 108 a level of control on the distribution and/or subsequent transfer of issuer tokens between recipients. For example, in one embodiment, the token transfer module 204 may be configured to access a given recipient's wallet 110 to check for the presence of a KYC token prior to allowing the recipient to purchase or otherwise acquire one or more issuer tokens, either at the offering or once the issuer tokens are freely traded between recipients.

The token transfer module 204 may also be configured to restrict access to an issuer token by the recipient or control the timing on when the transfer to a given recipient is completed. In one embodiment, the token transfer module 204 may receive a set of instructions that allow the transfer of one or more issuer tokens into the recipient's wallet 110 but prevent the recipient from accessing the issuer tokens until a predetermined event has taken place. The predetermined event may comprise any event or act determined by the party currently holding the issuer token. For example, the predetermined event may comprise a set number of days that must pass before the recipient of the issuer token is free to sell or trade the issuer token to another recipient.

In this manner it may be possible to allow issuer tokens to “vest” or otherwise become less than fully transferable before they can be subsequently sold or traded. Similar requirements may be used to create scenarios where issuer tokens may be treated as derivatives, options, futures, earn outs, or any other like method of treating a tokenized asset similar to a common security instrument, or time and other constraints in a commercial contract that may exist on a centralized system as opposed to a DL 104.

The token transfer module 204 may further be configured to allow for the transfer of tokens from the recipient wallet 110 without a password or the express authorization of the party owning the recipient account corresponding to the recipient wallet 110. For example, the transfer module 204 may be configured to allow a third party to access the recipient wallet 110 upon meeting certain criteria such as a having a court order. In this way, third parties such as an executor, a trustee, or creditor may be provided the ability to transfer tokens or coin from the recipient wallet 110 in accordance with a legal order from a court.

The tokenization system 100 may also comprise a reporting module (not shown) or otherwise comprise the ability to generate reports corresponding to the issuer tokens. For example, the tokenization system 100 may generate tax or other reports required for compliance with governmental regulatory or other commercial reporting requirements for recipients that cover all assets held in a given recipient's wallet 110. The tokenization system 100 may also be configured to generate regulatory compliance reports on behalf of the issuer 108 that preserve the anonymity of the recipient from the issuer 108.

In one embodiment, the reporting module may be configured to generate tax, financial reporting, or other compliance documents for recipients based on the presence of a KYC token in the respective recipient's wallet 100. The reporting module may also be configured to generate a single tax, financial reporting, or other like document for recipients having multiple wallets 110 that are all linked to a single KYC token.

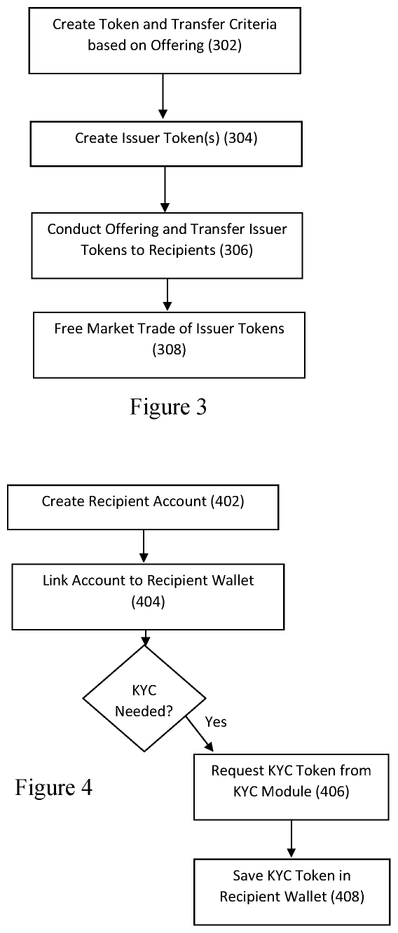

Referring now to FIG. 3, in operation, an issuer 108 may access the issuer module 208 and enter issuer data relating to a token offering such as a new ITO (302). The offering may correspond to any type of security, derivative, or other asset that may be tokenized and purchased by the recipient for a predetermined amount of coin. The tokenization system 100 may use the issuer data to create a plurality of issuer tokens on one or more DLs (304) where each issuer token represents some portion or share of the security offered in the offering. Once created, the issuer tokens may be initially transferred to one or more recipients as part of the offering (306). Subsequent to the offering, the issuer tokens may be freely traded, sold, exchanged, or otherwise transferred among additional recipients (308) on the DL. A similar process may be used for any subsequent token offerings from the same issuer 108.

A recipient interested in a token offering may access the tokenization system 100 to create a user account linked to the DL that may allow the recipient to purchase the issuer token. For example, referring now to FIG. 4, in one embodiment, the recipient may access the recipient module 202 and create an recipient account based on a set of recipient data saved into the recipient module 202 (402). The recipient module 202 may then connect to one or more wallets 110 owned by the recipient and link the wallet(s) 110 to the recipient account (404). If necessary, the recipient module 202 may then request a KYC token from the qualification module 206 (406). After receiving the KYC token from the qualification module 206, the KYC token is saved in the recipient's wallet(s) 110 (408).

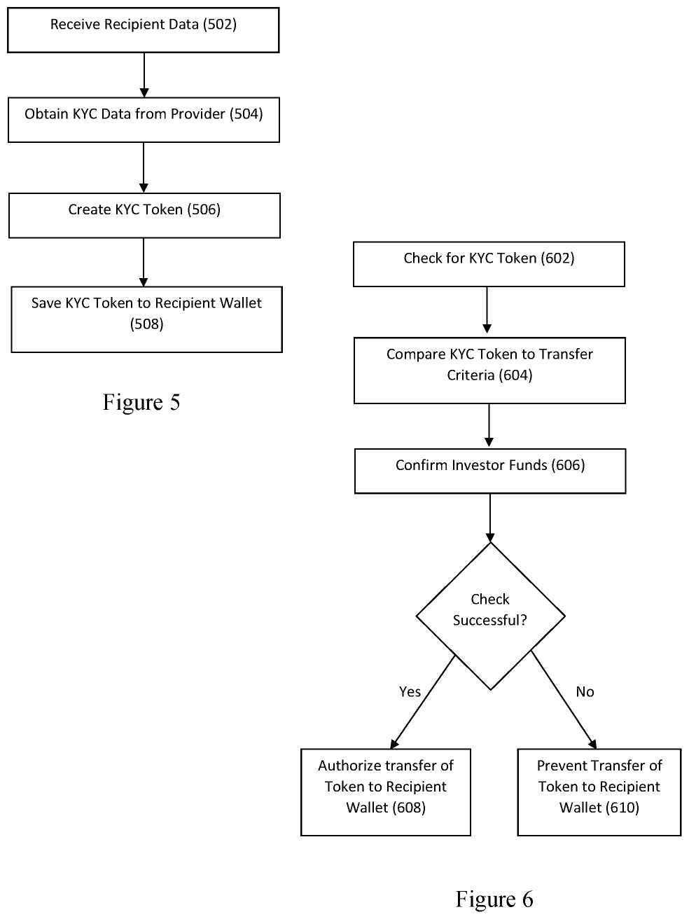

The process of generating the KYC token and/or the AML, token may be controlled by the qualification module 206. The qualification module 206 uses the recipient data to obtain a set of KYC data from a third party provider that is used to create the KYC token. For example, referring now to FIG. 5, the qualification module 206 receives recipient data from the recipient module 202 for one or more recipients (502). The recipient data may then be used to obtain KYC data for each recipient from a KYC provider (504). The qualification module 206 uses the received KYC data along with at least a portion of the recipient data to create a KYC token for each recipient (506). The KYC token may also include a set or subset of the transfer criteria established by the issuer 108 that is associated with the issuer tokens. Created KYC tokens may then be stored in the wallet(s) 110 of the corresponding recipient identified in the recipient's account or the set of recipient data (508). A similar process may be used to create an AML, token or the AML token may be linked to one or more KYC tokens created for others.

The tokenization system 100 may also be configured to utilize the KYC token in additional ways. For example, in one embodiment, the KYC token may be used as a master key allowing the recipient to log into a web site without needing a separate login/password combination. In addition, the KYC token may be used as an authentication device for allowing payments from the recipient's wallet 110.

The process of transferring the issuer tokens is controlled by the token transfer module 204. Prior to the transfer of any issuer token, the token transfer module 204 performs a check to ensure that the recipient attempting to purchase or receive the issuer token is qualified to do so. If the intended receiver of the issuer token isn't qualified to own the token, then the transfer of the issuer token is prevented from occurring. If the token transfer module 204 determines that the intended receiver of the issuer token is qualified to receive the issuer token, then the transfer is allowed to complete.

For example, in one embodiment, the check performed by the token transfer module 204 may be based, at least in part, upon confirmation of the identity of the recipient, person, or entity attempting to receive the issuer token. Referring now to FIG. 6, in one embodiment, the token transfer module 204 accesses the recipient's wallet 110 and checks for the presence of a KYC token corresponding to the issuer token attempting to be transferred (602). The token transfer module 204 may compare the data making up the KYC token against the set of transfer criteria created for the issuer token (604). Alternatively, if the set of transfer criteria is used as part of the data to generate the KYC token, then the check performed by the token transfer module 204 may be as simple as ensuring that the recipient's wallet 110 has the appropriate KYC token. In a further step of the check process, the token transfer module 204 may also confirm the recipient has the appropriate funds for the transaction such as: by an electronic funds transfer confirmation, receipt of a wire transfer, or checking to make sure that the wallet(s) 110 of the recipient attempting to purchase the issuer token(s) has the proper amount of coin in their wallet(s) 110 for the transaction (606). If the check is successful, then the token transfer module 204 will not prevent the transfer of the issuer token from the issuer to the wallet 110 of the recipient (608). If the check determines there is a problem, such as the recipient's wallet 110 does not contain the appropriate KYC token or the transfer criteria does not match completely, then the token transfer module 204 will constrain the transfer and prevent the recipient from acquiring the issuer token (610).

The token transfer module 204 may be configured to perform the check to determine whether or not the recipient is qualified to receive the issuer token without need of the KYC data. For example, an intended recipient of an issuer token may be an employee of the issuer 108. In this instance the issuer token may comprise at least a portion of a salary, bonus, or vested payment. Since the identity of the intended recipient is already known, the token transfer module 204 may be configured to recognize that a KYC token isn't required to qualify the wallet 110 of this particular recipient.

After a token offering has been completed, any recipients holding the issuer tokens may be allowed to sell, trade, or otherwise transfer one or more of issuer tokens held in their wallet 110 to another recipient. In prior art DL systems, there are no constraints placed on tokens and they may be freely traded among any person or entity having a wallet on the DL. These existing systems allow those receiving, selling, and trading tokens to remain anonymous. This anonymity may lead to the problems discussed above creating regulatory compliance issues for both issuers and recipients.

Although the transfer from a first recipient to a second recipient is outside of the initial offering, the tokenization system 100 provides the issuer 108 with the ability to maintain constraints on who can receive the issuer tokens after the offering. For example, the transfer criteria associated with the issuer token on creation may remain with the issuer token throughout its lifetime. Therefore, before any subsequent transfer of the issuer token, the token transfer module 204 must perform a check to ensure that any subsequent recipient attempting to acquire the issuer token is qualified to do so. This may be accomplished, at least in part, by the KYC data obtained by the qualification module or the KYC token created for each recipient. Because the transfer criteria associated with the issuer token cannot be altered, the initial requirements set by the issuer are maintained. Therefore, the wallet 110 of any subsequent recipient must be qualified before the transfer can be completed. For example, any new recipient must have an appropriate KYC token in their wallet 110 that meets the transfer criteria linked to the issuer token. Alternatively, if the token transfer module 204 is able to qualify the new recipient without the need for KYC data or a KYC token, then the transfer may still be completed.

This ability of the issuer to maintain control over who can acquire the issuer tokens after an offering provides a level of assurance that the trading of the tokens can maintain compliance with various laws or regulatory requirements the issuer may be operating under. This control means that issuers can be more confident that they can raise capital via the issuance of digital coins or tokens without encountering regulatory compliance problems. This control also allows for the creation of “certified” exchanges where token trading may be performed in the open and with full regulatory compliance.

The tokenization system 100 may also comprise a funding module (not shown) configured to facilitate the conversion of coin held by the issuer 108 and coin recipients. For example, following a successful token offering, the issuer 108 may be in possession of an amount of coin that represents a certain fiat currency value. One option available to the issuer 108 is to try and sell the coin on an exchange at the then current market rate. However, for reasons discussed above, this option may create market instability and not provide the issuer 108 with the greatest value for their coin. Therefore, the funding module may be used as an alternative method for the issuer 108 to sell their coin to the market directly on the DL 104 without doing so over the exchange.

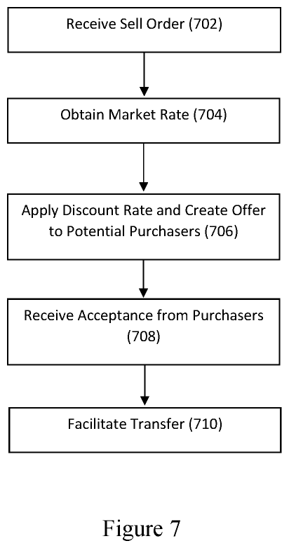

Referring now to FIG. 7, the funding module may be configured to receive a sell order from an issuer 108 for a given number of coin (702). The funding module may then determine a current market rate for the coin from one or more exchanges (704). After obtaining the current market rate, the funding module may apply a potential discount factor to the market rate and create an offer to purchase the coin at the agreed upon rate to recipients (706). One or more recipients may then respond to the offer by indicating to the funding module a desire to purchase some or all of the coin (708). The funding system may then facilitate the sale of the coin between the identified parties such that the transfer occurs directly on the DL 104 (710).

A benefit of transacting the sale of coin in this manner is that the overall market for the coin may be stabilized from major price fluctuations. By connecting the long-term recipient demand for responsible and well-structured access to coin currencies with the issuer's 108 desire for predictability and reliable fulfillment, currency risk can be transitioned from the operating business to an recipient with a risk premium. Conversely, the recipient has an opportunity to purchase coin below market price at a predictable rate and volume which allows recipients to have greater planning and visibility as well as a more orderly basis for hedging strategies.

These and other embodiments for methods of tokenizing securities may incorporate concepts, embodiments, and configurations as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

The crypto-currency market is immature and there are often contradictory and overlapping semantics in use by different individuals. For example, coin and token are both terms referring to digital assets on a distributed ledger. Sometimes they are also referred to as protocols because they are embodied by a particular set of capabilities. For example the Bitcoin coin is represented by the Bitcoin protocol.

Blockchain is a particular type of distributed ledger but the two terms are often used interchangeably. While Bitcoin and Ethereum are examples of blockchain type distributed ledgers, others like IOTA and Stellar are not blockchains but are also types of distributed ledgers.

Further, the acronyms ITO and ICO refer to initial token offering and initial coin offering respectively. The popular use of the term “initial,” however, should not imply the limitation of the capabilities described herein as pertaining only to “initial” offerings. Rather, the capabilities described above also apply to follow-on, ancillary, and other offerings as well as being important throughout the lifecycle of the token. The term Crowdfunding is sometimes used in place of ITO and ICO in an effort to avoid regulatory scrutiny but for the purposes of this filing such Crowdfunding, in so far as it generates a digital asset, is equivalent to an ITO.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

1. A method for tokenizing securities and assets associated with an offering created by an issuer and traded between at least one recipient, comprising:
creating and issuing an issuer token on a first distributed ledger corresponding to the offering;
performing a check to qualify a wallet of a first recipient;
transferring the issuer token to the wallet of the first recipient following a confirmation that the wallet of the first recipient has been qualified;
constraining any subsequent transfer of the issuer token between recipient wallets until a confirmation that a wallet of a second recipient has been qualified.

2. A method for tokenizing securities and assets according to claim 1, further comprising issuing the issuer token simultaneously on a second distributed ledger when the issuer token is issues to the first distributed ledger.

3. A method for tokenizing securities and assets according to claim 1, further comprising providing an alternative method of accessing the issuer token in response to a verified lockout request.

4. A method for tokenizing securities and assets according to claim 1, wherein all transfers of the issuer token occur directly on the first distributed ledger.

5. A method for tokenizing securities and assets according to claim 1, wherein the transfer of the issuer token to the wallet of the recipient is completed following an occurrence of a time based event.

6. A method for tokenizing securities and assets according to claim 1, wherein the subsequent transfer of the issuer token to the wallet of the second recipient is completed without the authorization of the first recipient in response to an occurrence of a predetermined event.

7. A method for tokenizing securities and assets according to claim 1, wherein qualifying the first and second wallets is based on a set of KYC data created for each wallet.

8. A method for tokenizing securities and assets according to claim 7, wherein the set of KYC data for each wallet is used to create a KYC token for each recipient.

9. A method for tokenizing securities and assets according to claim 8, wherein the created KYC token for each recipient is stored in their respective wallets.

10. A method for tokenizing securities and assets according to claim 9, wherein the KYC token is configured to act as an authentication device to allow payments from the corresponding wallet.

11. A method for tokenizing securities and assets according to claim 9, wherein the recipient wallets reside on a second distributed ledger.

12. A method for tokenizing securities and assets according to claim 8, wherein:
each KYC token comprises a set of transfer criteria generated by the issuer; and
the transfer of the issuer token to the second recipient is restricted if the set of transfer criteria of a second KYC token does not match the set of transfer criteria of a first KYC token.

13. A method for tokenizing securities and assets according to claim 8, wherein creating the KYC token comprises combining the set of transfer criteria with the set of KYC data.

14. A method for tokenizing securities and assets according to claim 8, wherein the KYC token is configured to be used as a master key for logging in to one or more websites.

15. A method for tokenizing securities and assets according to claim 7, wherein the set of KYC data is obtained from a third party provider.

16. A method for tokenizing securities and assets according to claim 1, further comprising generating an AML token for the issuer that is linked to the issuer token.

17. A method for tokenizing securities and assets according to claim 16, wherein:
the AML token is linked to at least one KYC token held in one or more issuer related wallets; and
each KYC token is created based on a set of KYC data for each issuer related wallet.

18. A method for tokenizing securities and assets according to claim 1, further comprising generating at least one of a compliance report and a tax report corresponding to the issuer token and the wallet the issuer token is residing in.

19. A method for tokenizing securities and assets according to claim 1, wherein the issuer token comprises a derivative.

20. A system for tokenizing securities and assets on a distributed ledger associated with an offering created by an issuer and traded between at least one recipient wallet, comprising:
a tokenization system, comprising:
an issuer module configured to create and issue an issuer token on a first distributed ledger according to a set of issuer data;
a recipient module configured to create an recipient account according to a set of recipient data; and
a token transfer module configured to transfer the issuer token from the issuer module to a wallet of a first recipient; and
a qualification module configured to qualify the wallet of the first recipient according to:
a set of recipient data; and
a set of transfer criteria included in the issuer data,
wherein the transfer of the issuer token to the wallet of the first recipient is constrained until the qualification module confirms that the wallet of the first recipient is qualified to receive the issuer token.

21. A system for tokenizing securities and assets on a distributed ledger according to claim 20, wherein the issuer module is configured to issue the issuer token simultaneously on a second distributed ledger when the issuer token is issued to the first distributed ledger.

22. A system for tokenizing securities and assets on a distributed ledger according to claim 20, wherein the qualification module is configured to create:
a KYC token comprising:
the set of recipient data;
a set of KYC data; and
the set of transfer criteria; and
store the KYC token in the wallet of the first recipient.

23. A system for tokenizing securities and assets on a distributed ledger according to claim 22, wherein the wallet of the first recipient resides on a second distributed ledger.

24. A system for tokenizing securities and assets on a distributed ledger according to claim 22, wherein the KYC token is configured to act as an authentication device to allow payments from the wallet.

25. A system for tokenizing securities and assets on a distributed ledger according to claim 22, wherein the KYC token is configured to be used as a master key for logging in to one or more websites.

26. A system for tokenizing securities and assets on a distributed ledger according to claim 22, wherein the qualification module is configured to receive the KYC data from a third party provider.

27. A system for tokenizing securities and assets on a distributed ledger according to claim 20, wherein the tokenization system is further configured to constrain any subsequent transfer of the issuer token between a recipient wallet holding the issuer token and a second recipient wallet intending to receive the issuer token until the qualification module confirms that the wallet of the second recipient is qualified to receive the issuer token.

28. A system for tokenizing securities and assets on a distributed ledger according to claim 27, wherein the transfer of the issuer token to the second recipient wallet is restricted if the set of transfer criteria in the second recipient wallet does not match the set of transfer criteria in the issuer data.

29. A system for tokenizing securities and assets on a distributed ledger according to claim 20, wherein the subsequent transfer of the issuer token to the wallet of the second recipient is completed without the authorization of the first recipient in response to an occurrence of a predetermined event.

30. A system for tokenizing securities and assets on a distributed ledger according to claim 20, wherein the token transfer module is further configured to provide an alternative method of accessing the issuer token in response to a verified lockout request.

31. A system for tokenizing securities and assets on a distributed ledger according to claim 20, wherein the token transfer module is further configured to the transfer of the issuer token to the wallet of the first recipient is completed following an occurrence of a time based event.

32. A system for tokenizing securities and assets on a distributed ledger according to claim 20, wherein the qualification module is further configured to generate an AML token for the issuer that is linked to the issuer token.

33. A system for tokenizing securities and assets on a distributed ledger according to claim 32, wherein:
the AML token is linked to at least one KYC token held in one or more issuer related wallets; and
each KYC token is created based on a set of KYC data for each issuer related wallet.

34. A system for tokenizing securities and assets on a distributed ledger according to claim 20, wherein the tokenization system is further configured to generate at least one of a compliance report and a tax report corresponding to the issuer token and the wallet the issuer token is residing in.

35. A system for tokenizing securities and assets on a distributed ledger according to claim 20, wherein the issuer token comprises a derviative.

36. A system for tokenizing securities and assets on a distributed ledger according to claim 20, further comprising a funding system configured to:
receive a coin sell order from the issuer;
assign a discount rate to the coin sell order;
identify a party to purchase the coin at the discount rate; and
facilitate the coin sell order between the party and the issuer without the use of an exchange off of the distributed ledger.
